(19) United States
(12) Patent Application Publication
(10) Pub. No.: US 2026/0358649 A1
(43) Pub. Date: Nov. 12, 2026

(54) LENS ELEMENT

(71) Applicant: SightGlass Vision, Inc., Dallas, TX (US)

(72) Inventors: Montserrat Burgos Piedmont, Charenton-Le-Pont (FR); Solange Ponot, Lyon (FR); Guillaume Ged, Montigny Le Bretonneux (FR); Joseph Martin, Montgeron (FR); Florian Soffiatti, Villejuif (FR)

(21) Appl. No.: 19/139,794

(22) PCT Filed: Dec. 16, 2022
(86) PCT No.: PCT/US2022/053211

§ 371 Date: Jun. 16, 2025

(51) Int. Cl. G02C 7/02; B29D 11/00; G02B 1/11; G02B 1/14

(52) U.S. Cl. CPC G02C 7/022; B29D 11/00336; G02B 1/11; G02B 1/14; G02C 2202/24

(57) ABSTRACT

The invention relates to a lens element intended to be worn in front of an eye of a wearer comprising a substrate with a front face and a rear face, and optical elements located on one of the front or rear face of the lens element, said optical elements being realized in form of blind holes with respect to the face surface and providing a contrast reduction on the retina of the wearer contributing to myopia control, where at least one optical element has a peak-to-valley dimension (PV) of equal or less than 25 μm.

### TECHNICAL FIELD

The present disclosure relates to a lens element intended to be worn in front of an eye of a person in particular to suppress, reduce progression or control abnormal refractions of the eye such as myopia or hyperopia. The lens element is in particular an ophthalmic article.

The term “ophthalmic article” is specifically understood to mean a lens, corrective or otherwise, that can be used as spectacle glass, for spectacles for example, particularly sunglasses, goggles, visors or the like or a contact lens worn by the user in direct contact with his eye.

### BACKGROUND OF THE DISCLOSURE

Myopia of an eye is characterized by the fact that the eye focuses distant objects in front of its retina. Hyperopia of an eye is characterized by the fact that the eye focuses distant objects behind its retina. Myopia is usually corrected using a concave lens and hyperopia is usually corrected using a convex lens.

It has been observed that some individuals, in particular children, when provided vision correction using conventional single vision optical lenses, focus inaccurately when they observe an object which is situated at a short distance away, that is to say, in near vision conditions. Because of this focusing defect on the part of a myopic child who is corrected for his far vision, the image of an object close by is also formed behind his retina, even in the foveal area.

Such focusing defect may have an impact on the progression of myopia of such individuals. One may observe that for most of said individuals the myopia defect tends to increase over time.

Foveal vision corresponds to viewing conditions for which the image of an object looked at is formed by the eye in the central zone of the retina, called the foveal zone.

Peripheral vision corresponds to the perception of elements of a scene that are offset laterally relative to the object looked at, the images of said elements being formed on the peripheral portion of the retina, away from the foveal zone.

The ophthalmic correction with which an ametropic subject is provided is usually adapted for his foveal vision. However, as is known, the correction has to be reduced for the peripheral vision relative to the correction that is determined for the foveal vision. In particular, studies carried out on monkeys have shown that focusing the light far behind the peripheral retina, even with simultaneous light perfectly focused on the fovea, causes the eye to elongate and therefore causes a myopia defect to increase.

Therefore, it appears that there is a need for a lens element that would suppress, control or at least slow down progression of abnormal refractions of the eye such as myopia or hyperopia.

WO2019206569 in the name of the applicant proposes solutions by disclosing lens elements having optical elements which provide in particular a focus shifting leading to a function of non-focusing an image on the peripheral retina of the eye in standard wearing conditions.

However, it has been observed that some lenses equipped with dot shaped lens elements for myopia control exhibit an unpleasant hazy white perception from an observer point of view. Such a hazy white veil can easily be seen when the lens elements are placed against coloured surfaces or dark backgrounds, for example in cases in which spectacles equipped with such lens elements are put on a dark coloured table or someone's skin.

The present disclosure aims to provide improved lens elements that show at least less or no white hazy perception from an observer point of view while providing at the same time efficient myopia or hyperopia control.

### SUMMARY OF THE DISCLOSURE

In order to achieve this goal, the present disclosure proposes a lens element intended to be worn in front of an eye of a wearer comprising a substrate with a front face and a rear face, and optical elements located on one of the front or rear face of the lens element, said optical elements being realized in form of blind holes with respect to the face surface and providing a contrast reduction on the retina of the wearer contributing to myopia control, where at least one optical element has a peak-to-valley dimension of equal or less than 25 μm.

The present disclosure also proposes a method for manufacturing a lens element intended to be worn in front of an eye of a wearer comprising a substrate with a front face and a rear face, and optical elements located on one of the front or rear face of the lens element, said optical elements being realized in form of blind holes with respect to the face surface and providing a contrast reduction on the retina of the wearer contributing to myopia control, where at least one optical element has a peak-to-valley dimension of equal or less than 25 μm. The method may comprise a laser engraving step using a laser having an engraving wavelength of equal or less than 355 nn, in particular 355 nm or 266 nm.

According to further aspects taken alone or in combination relating to the above defined lens element:
the optical elements may be blind holes realized by laser ablation.
The lens element may further comprise anti-reflective coating.
The lens element may further comprise a hard coat having a refractive index 1.6+/−2 %.
The hard coat may comprise a compound enhancing laser absorption between 250 nm and 370 nm.
In that case, the laser absorption enhancing compound may comprise a metallic oxide or a colloid containing a metal.
The face of the lens element presenting within a zone and delimited by the optical elements may show a power spectral density of 1010 nm-3 +/−10%.
The border of at least one blind hole (14) may protrude less than 5 μm from the surrounding face surface (16) presenting the optical elements (14).
One optical element may have a peak-to-valley dimension of equal or less than 15 μm.
The substrate may exhibit 0% transmission for a 2 mm layer at the ablation wavelength of the laser.
The hard-coat may exhibit an extinction factor (k) higher than 0.005, preferably higher than 0.05 in a wavelength range between 250-355 nm.
The diameter of the blind holes may be between 170μm and 220 μm.
The spacing of the centres of two neighbouring blind holes may be between 300μm and 420 μm.
A haze level of the lens element may exhibit 15% +/−5%.
The lens element may comprise a non-engraved circular centre zone (16C).
The non-engraved circular centre zone may have a diameter of 3.5 mm.
The non-engraved circular centre zone may be surrounded by a annular zone where the diameter of the blind holes gradually increases from 40 μm to at least 170 μm.
The method may be such that the laser engraving step comprises use of laser pulses.
The duration of the laser pulses may be between 10 μs and 100 μs.
The laser beam may be focused and have a spot size between 1250 μm² and 12500 μm² when impinging the lens element.

### BRIEF DESCRIPTION OF THE DRAWINGS

Other advantages and features will become apparent upon reading the description of the following figures, among which:

FIG. 1 is a plan view of a lens element according to an embodiment of the disclosure;

FIG. 2 is a general profile view of a lens element according to an embodiment of the disclosure;

FIG. 3 is a plan view of a lens element according to another embodiment of the disclosure;

FIG. 4 is a simplified cross sectional view of a blind hole according to the present disclosure,

FIG. 5 shows in a graphics the peak to valley dimension in function of an average visual score,

FIG. 6 is a picture for explaining a protocol how the average visual score is obtained,

FIGS. 7 and 8 are similar views as FIG. 2 of different embodiments, and

FIG. 9 is a similar view as FIG. 1 of a further embodiment of a lens element of the present disclosure.

### DETAILED DESCRIPTION

On all the figures, the same elements bear the same reference numbers.

The following embodiments are only examples. Although the description refers to one or several embodiments, the invention is not limited to these embodiments. In addition, a feature described in relationship with one embodiment may also concern another embodiment even if this is not mentioned expressively. Simple features of different embodiments may also be combined to provide further realizations.

In the present description, by “front” or “rear” face of a layer or a lens element or surface, reference is made to the propagation of the rays of light towards the eye through the ophthalmic lens when an ophthalmic device bearing the ophthalmic lens is worn on a wearer's face. Thus a “front” face is always that which is farthest away to the eye of the user and therefore closest to the field of view and a “rear” face is always that which is closest to the eye of the user.

The terms “upstream” or “downstream” are used in relationship with the propagation of light from the outside, through the lens element, and toward the retina of the eye of the wearer when the lens element is worn by the wearer. Thus, a first thing (a surface, a layer, an image etc.) is located upstream of a second thing when the light passes through its path towards the retina of the wearer first through the first thing and then through the second thing.

For example, an image is located upstream or upfront the retina of the wearer's eye when the image is located in front of the retina between the pupil and the retina.

Conversely, a first thing is located “downstream” of a second thing when the light passes through its path towards the retina of the wearer first through the second element and then through the first element. Thus, the retina of the wearer is located downstream of both the lens element and the pupil of the wearer.

The disclosure relates to a lens element intended to be worn in front of an eye of a wearer.

In the context of the present disclosure, the term “lens element” can refer to a lens blank, an uncut optical lens, a spectacle optical lens edged to fit a specific spectacle frame or an ophthalmic lens.

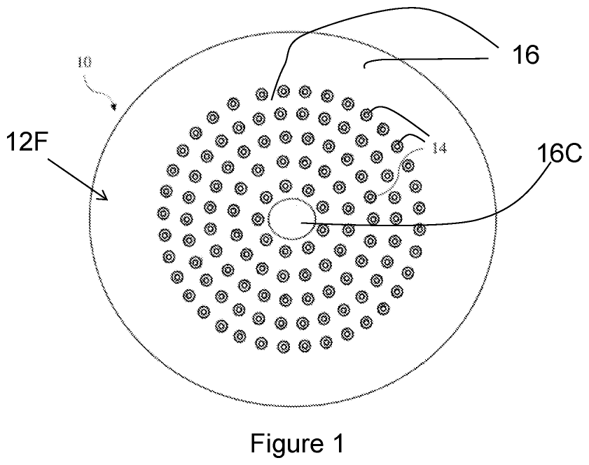

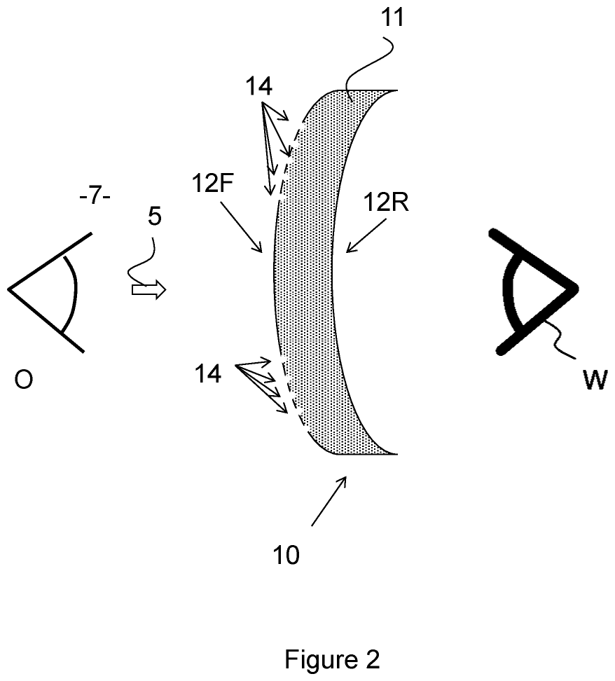

As represented on FIGS. 1 and 2, a lens element 10 according to the disclosure comprises a substrate 11 with a front face 12F and a rear face 12R.

As shown in FIG. 2, the light incident on the ophthalmic article 1 is shown by the arrow 5 and an eye W represents a user/wearer of the lens element 1. The field of view 7 is thus situated on the side of the arrow 5 and the user “W” looks through the lens element 1 with his eye. Upstream the lens element 1 is also located an observer “O” who is looking in the direction of the wearer “W”. The wearer “W” is located downstream the lens element 10.

The substrate 11 is for example made of a plastic material, for instance a polymer substrate like a thermoset, in particular made of poly(urea-urethane), or thermoplastic plastic material, in particular made of polyamide (PA), like nylon or a polycarbonate, polyester or TRIVEX(C) (registered trademark). As an alternative, a PET or TAC film, or any other suitable material, may be present on the substrate, on either of its surface, for example added by lamination. In the example of FIGS. 1 and 2, optical elements 14 are located on the front face 12F of the lens element 10. The optical elements 14 are spaced apart from one another on the front face 12F. In a not shown alternative, the optical elements 14 can be located on the rear face 12R or on both faces, the front 12F and the rear 12R face. In above-mentioned examples in which a film material is present on the substrate 11, the optical elements 14 may be located on the film material.

The area of the front face 12F other than the areas formed by the plurality of optical elements 14 is designated as the refractive area 16. In other words, the refractive area 16 is the complementary area to the areas occupied by the plurality of optical elements 14.

The refraction area 16 is configured to provide to the wearer in standard wearing conditions, in particular for foveal vision, a first optical power based on the prescription of the wearer for correcting an abnormal refraction of said eye of the wearer. The object of the refraction area 16 is to focus incoming parallel light on the retina.

The wearing conditions are to be understood as the position of the lens element 10 with relation to the eye of a wearer, for example defined by a pantoscopic angle, a Cornea to lens distance, a Pupil-cornea distance, a center of rotation of the eye (CRE) to pupil distance, a CRE to lens distance and a wrap angle.

As can be seen on FIG. 2, the optical elements 14 are realized as blind holes which are also referenced “14”.

Such blind holes 14 can be made in various ways, in particular by laser ablation, but also by mechanical drilling or percussion or etching or embossing or moulding with a specific mould presenting specific protrusions or 3D printing a surface with holes, or any other relevant technology.

The lens element 10 comprises furthermore a non-engraved circular centre zone 16C which is fully part of the refraction area 16 and designed to be placed in front of the wearer's pupil when worn. The non-engraved circular centre zone 16C is also designated as COCA (circle of clear aperture). The blind holes 14 can surround the non-engraved circular centre zone 16C.

The non-engraved circular center zone 16C has for example a diameter of 3.5 mm.

In the present example, the blind holes 14 are disposed in circular concentric rings around the circular centre zone 16C.

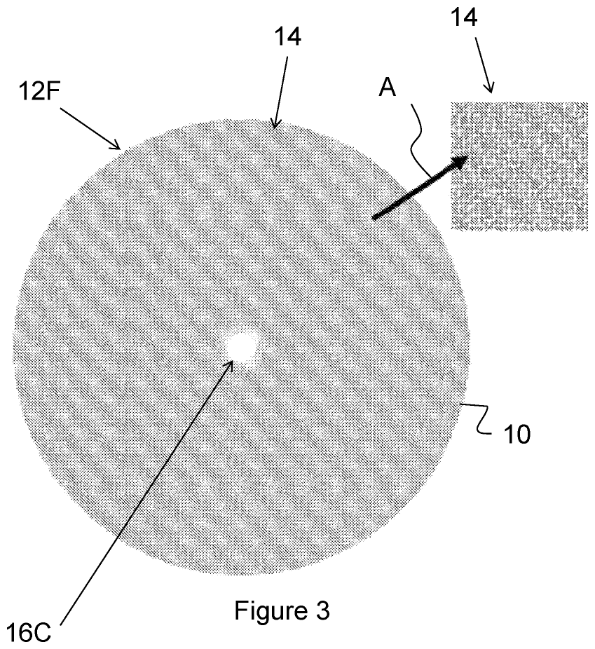

Another configuration is shown in FIG. 3. FIG. 3 is similar to FIG. 1 and shows a top view of a lens element 10. According to this embodiment, the blind holes are disposed according to randomized squared arrays. Arrow A points to an enlarged/zoomed view of blind holes.

The diameter of the blind holes 14 according to this embodiment is in particular in a range between 170 μm and 220 μm.

The spacing of the centres of two neighbouring blind holes 14 is for example between 300 μm and 420 μm.

Other configurations like for example a hexagonal pattern or randomized circular arrays may also be envisaged.

The optical elements formed in this disclosure as blind holes 14 aim to produce non-focalised light, thus providing a contrast reduction, for example in front of the retina in order to slow down myopia progression. Said blind holes 14 provide a scattering effect on an incoming light beam impinging the retina of the wearer, thereby contributing to control of myopia progression.

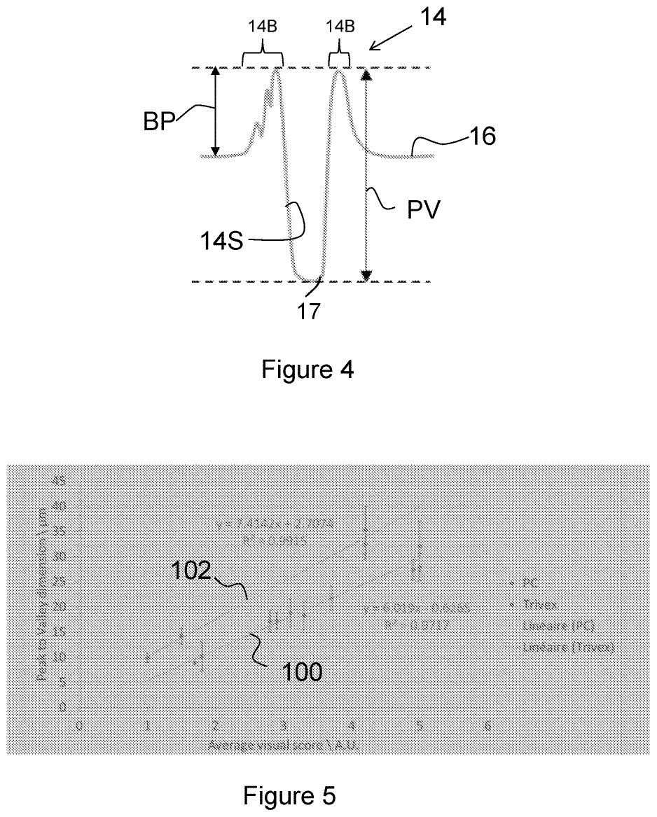

Turning now to FIG. 4 which is a simplified cross sectional view of a blind hole 14 according to the present disclosure.

The blind hole 14 is of a general circular shape (see FIG. 1) with straight side walls 14S, a surrounding border 14B which can protrude with respect to the refraction area 16, and a terminal end 17. The straight side walls 14S extend from the border 14B to the terminal end 17 of the blind hole 14. The straight side walls 14S can be angled relative to or parallel to a longitudinal axis of the blind hole 14. The terminal end 17 is recessed relative to the border 14B and relative to the refraction area 16, e.g., relative to the surface defining the refraction area 16.

FIG. 4 also defines a parameter PV (peak-to-valley) and a parameter BP (border protrusion). The parameter PV is the depth of the blind hole 14 relative to the height of the border 14B. The parameter BP is the height of protrusion of the border 14B with respect to the refraction area 16.

The inventors have found an optical element 14 having a peak-to-valley dimension PV of equal or less than 25 μm, in particular equal or less than 15 μm, allows obtaining lens elements 10 with diminished white hazy perception from an observer point while having still a positive effect on myopia control.

Such an optical element 14 can have a peak-to-valley dimension PV of at least 3 μm, preferentially at least 4 μm for providing efficient myopia control.

FIG. 5 shows the result of a study where lens elements with different PV values were manufactured and evaluated. FIG. 5 is a graphics showing the peak to valley dimension PV of the lens elements as a function of an average visual score, which is obtained using a process described below.

Linear regression line 100 shows the average visual score as a function of the value of the parameter PV for lens elements where the substrate was made of polycarbonate material.

Linear regression line 102 shows the average visual score as a function of the value of the parameter PV for lens elements where the substrate was made of TRIVEX(C) (registered trademark) material.

In both cases, a smaller PV value resulted in an improved average visual score.

In order to obtain the average visual score, a testing protocol was defined.

The lens elements 10 were inspected under specific lighting conditions by two independent observers with a CIE standard using D65 illuminant, without ceiling light and in a room with black-out curtains.

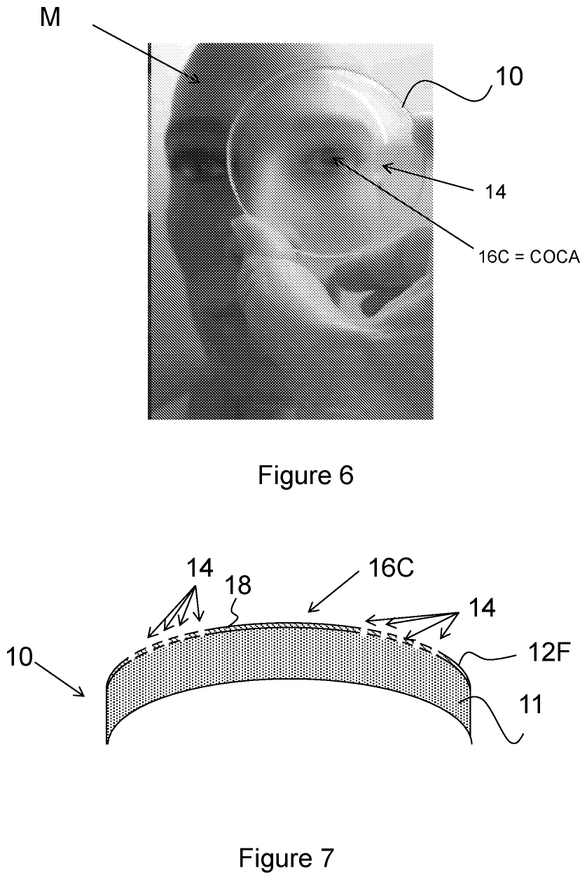

Two criteria (described below) were analyzed on two different backgrounds: one background is black and one background is a Caucasian mannequin M as shown in FIG. 6.

The black background provided a higher contrast environment for observing the lens elements that was more likely to give discriminating results. On the other hand, the mannequin M provided a more realistic environment to emulate a situation in which another person was observing the wearer.

The observers evaluated the following two criteria:
=>the engraving visibility of the optical elements/blind holes 14
=>the visibility of COCA (circle of clear aperture) which corresponds to the non-engraved circular center zone 16C.

The observers used a continuous scale in a range between 1 and 5 where 1 corresponds to less visible and 5 to most visible.

Thus a lower visual score indicates that a decreased white haziness on the lens element 10 was perceived by an observer looking on the wearer of the lens element 10.

The lens element 10 was considered to have better performance the less the COCA was visible.

The optical elements/blind holes 14 were located in an annulus, with its inner circle boundary forming the COCA 16C, the outer circle boundary of the annulus being either the edges of the lens element or a smaller shape within the lens element. The annulus may be non-circular. The lens element 10 was considered to perform better the less the engraved optical elements/blind holes 14 were visible. It is reminded that the “performance” mentioned here was considered to be an aesthetic performance and not the performance of the blind holes to control myopia.

From FIG. 5, one can clearly derive that the peak-to-valley has a clear influence on the average visual score.

Furthermore, it was observed that in cases in which the blind hole 14 protruded less than 5 μm (BP<5 μm) from the surrounding face surface forming the refractive area 16, the performance of the lens element from an observer point of view was further improved. In particular, the optical elements/blind holes 14 were less visible to the observer.

Moreover, a “fading” effect on the visibility of the blind holes 14 and the COCA 16C, meaning that the blind holes 14 and the COCA were less visible and the lens element received a lower average visual score, was observed when the face of the lens element 10, in the present example, the front face 12F, are positioned within a zone delimited by the optical elements 14 which has an annulus around the COCA (e.g., as in FIG. 1) and a power spectral density (PSD) of 10¹⁰ nm⁻³ (+/−10%) in a spectral spatial band between 10 mm⁻¹ and 80 mm⁻¹.

The power spectral density (PSD) was measured optically by acquisition of surface height measurement with an optical interferometer.

The calculation of the Power spectral density (PSD) from the height maps was realized according to the following article: “AZOUIGUI, S., SILVESTRI, Z., ZERROUKI, C., BOUHTIYYA, S., PLIMMER, M.D., SPALTMANN, D., KOVALEV, A., WOYDT, M. and PINOT, P., 2015. Angle resolved scattering as a tribological investigation tool for surface characterization. Wear. Mar. 2015. 326-327, p. 58-67. DO/10.1016/j.wear.2014.12.040.”

The power spectral density PSD was calculated within an area comprising several blind holes 14. Typically, the PSD can be determined within a square area of 4 mm×4 mm which corresponds to about sixty blind holes 14 in the investigated samples.

Methods for manufacturing lens elements are disclosed herein. As stated above, the blind holes 14 can be made in particular by laser ablation.

Laser ablation comprises a laser engraving step using a laser having an engraving wavelength of equal or less than 355 nn, in particular 355 nm or 266 nm.

The laser engraving step comprises use of laser pulses. The pulses have for example a duration between 10 μs and 100 μs.

Laser light at a shorter wavelength has higher energy for ablation as longer wavelength. Therefore, as an example, pulse duration at 266 nm laser wavelength is for example 30 μs whereas for a laser wavelength at 355 nm, pulse duration may be about 85 μs.

For laser engraving, the laser beam is focused and has a spot size between 1250 μμm² and 12500 μm² when impinging the lens element 10.

FIG. 7 shows a further development of the lens element 10 which differs from FIG. 2 in that the lens element 10 includes a hard coat 18 disposed on the substrate 11.

An example of a hard coat 18 is a polysiloxane, as mono-or bilayer for example, with a thickness between 2.5-4.5 μm.

During laser ablation, the blind holes 14 are drilled through the hard coat 18 and into the substrate 11 until a certain depth is reached, the peak-to-valley value PV of the blind holes 14 accounting for the thickness of the hard coat layer 18.

In order to facilitate laser ablation for the blind hole laser drilling, the hard coat 18 has a refractive index of 1.6+/−2%.

Improvements for laser ablation can be reached where the hard coat comprises a compound enhancing laser absorption between 250 nm and 370 nm. Such a compound enhancing laser absorption comprises for example a metallic oxide or colloids containing metals. As examples, colloids of zirconium or tantalum, titanium or tin can be mentioned, where colloids of zirconium or tantalum are less absorbent compared to colloids of titanium or even than colloids of tin. In other words, more aesthetically appealing product are obtained when using colloids of tin or titanium.

Moreover, a further parameter of the hard coat 18 to enhance engraving and to obtain an improved average visual score concerns the extinction factor k>0.005 within a wavelength range between 250-355 nm, preferentially 0.05<k<0.5 in 260-355 nm.

In addition, enhancement of engraving and improvement of average visual score is achieved when the substrate exhibits a non-null absorption for a null transmission in the wavelength range between 250-355 nm corresponding to the ablation wavelength of the laser. An example of a substrate having incorporated an absorbing compound like for example 2-(3-tert-butyl-2-hydroxy-5-methylphenyl)-5-chloro-2H-benzotriazole which acts as an UV absorber. This compound absorbs UV light between 340-355nm depending on the specific composition and is compatible with almost all synthetic resins.

By using a laser with a wavelength close to 266 nm, better performances can be achieved as most organic materials transparent in the visible light range absorb light close to 266 nm even without any additional compounds. Furthermore, the absorption is done directly by the material of the polymeric matrix and not within the compound. Accordingly it is thought that this facilitates the control of the marking.

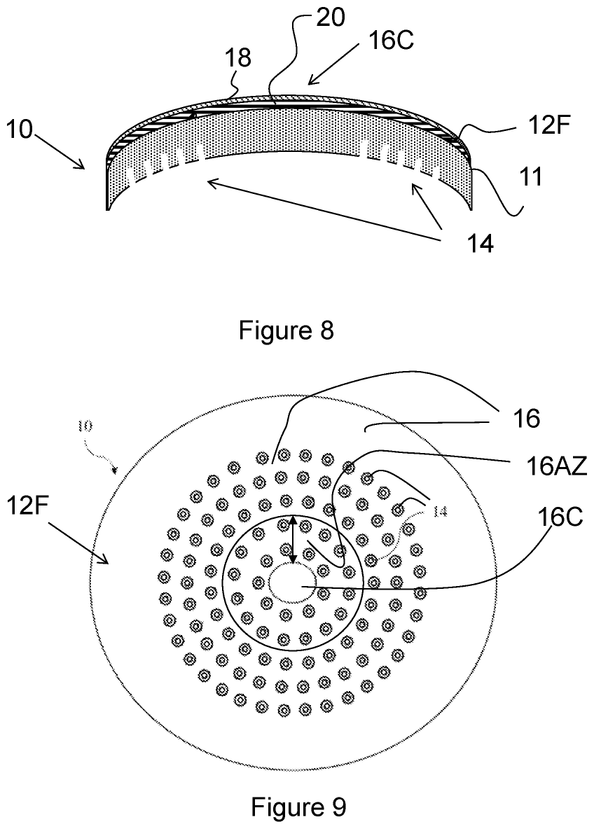

According to a further development shown in FIG. 8, an anti-reflective coating 20 is interposed between the substrate 11 and the hard coat 18 which also contributes to enhance engraving and to obtain an improved average visual score.

The laser ablation causes drilling of blind holes through the hard coat 18, the anti-reflective coating 20 and partially in the substrate 11. In FIG. 8 like in the other figures, the size of the blind holes 14 has been exaggerated for presentation purposes.

A lens element 10 according the present disclosure and according to all different embodiments exhibits a Haze level of 15% +/−5% in transmission, as defined in standard ASTM D-1003.

According to a further embodiment shown in FIG. 9, the non-engraved circular centre zone 16C is surrounded by an annular zone 16AZ where the diameter of the blind holes 14 gradually increases from a first diameter, e.g., 40 μm, to a second diameter, e.g., at least 170 μm. As indicated by the arrow, the width of annular zone 16AZ which can be considered a “transition zone”, may be for example 1.5 mm. This feature in particular contributes to rendering the COCA 16C less visible.

1. A lens element intended to be worn in front of an eye of a wearer comprising a substrate with a front face and a rear face, and optical elements located on one of the front or rear face of the lens element, said optical elements being realized in form of blind holes with respect to the face surface and providing a contrast reduction on a retina of the wearer contributing to myopia control, where at least one optical element has a peak-to-valley dimension (PV) of equal or less than 25 μm.

2. A lens element according to claim 1, where the optical elements are blind holes realized by laser ablation.

3. A lens element according to claim 2, further comprising anti-reflective coating.

4. A lens element according to claim 1, further comprising a hard coat having a refractive index 1.6+/−2 %.

5. A lens element according to claim 4, the hard coat comprising a compound enhancing laser absorption between 250 nm and 370 nm.

6. A lens element according to claim 5, where the laser absorption enhancing compound comprises a metallic oxide or a colloid containing a metal.

7. A lens element according to claim 1, wherein the face of the lens element presenting within a zone and delimited by the optical elements shows a power spectral density of 10¹⁰ nm⁻³ +/−10%.

8. A lens element according to claim 1, wherein a border of at least one blind hole protrudes less than 5 μm from the surrounding front face presenting the optical elements.

9. A lens element according to claim 1, wherein the one optical element has a peak-to-valley dimension of equal or less than 15 μm.

10. A lens element according claim 2, wherein the substrate exhibits 1% transmission or less for a 2 mm layer at an ablation wavelength of the laser, preferably 0.1% or less, and more preferably 0.01% or less.

11. A lens element according to claim 4, wherein the hard-coat exhibits an extinction factor (k) higher than 0.005, preferably higher than 0.05 in a wavelength range between 250-355 nm.

12. A method for manufacturing a lens element intended to be worn in front of an eye of a wearer comprising a substrate with a front face and a rear face, and optical elements located on one of the front or rear face of the lens element, said optical elements being realized in form of blind holes with respect to the front face and providing a contrast reduction on a retina of the wearer contributing to myopia control, where at least one optical element has a peak-to-valley dimension (PV) of equal or less than 25 μm, the method comprising a laser engraving step using a laser having an engraving wavelength of equal or less than 355nn, in particular 355 nm or 266 nm.

13. The method according to claim 12, wherein the laser engraving step comprises use of laser pulses.

14. The method according to claim 13, wherein a duration of the laser pulses is between 10 μs and 100 μs.

15. The method according to claim 12, wherein a laser beam of the laser is focused and has a spot size between 1250 μm² and 12500 μm² when impinging the lens element.
